(19) United States
(12) Patent Application Publication
(10) Pub. No.: US 2025/0299147 A1
(43) Pub. Date: Sep. 25, 2025

(54) USING A TRAINED MODEL TO PREDICT AND PREVENT FAILED DELIVERIES

(71) Applicant: Maplebear Inc., San Francisco, CA (US)

(72) Inventors: Sandrine Meunier, Bellevue, WA (US); Aneesh Mannava, San Francisco, CA (US); Rebecca Riso, Croton-On-Hudson, NY (US); Shrihari Murlidharan, Walnut Creek, CA (US); Chujian Bi, Santa Clara, CA (US); Ashish Sinha, Jersey City, NJ (US); Krishna Kumar Selvam, San Francisco, CA (US)

(21) Appl. No.: 18/614,563

(22) Filed: Mar. 22, 2024

(51) Int. Cl. G06Q 10/083; G06N 5/022

(52) U.S. Cl. CPC G06Q 10/083; G06N 5/022

(57) ABSTRACT

A trained model is used to predict and prevent a failed delivery of an order placed by a user of an online system. The online system accesses a delivery prediction model trained to predict a likelihood of a delivery for the order ending up as a failed delivery as the order would not be delivered at a location associated with the user. The online system applies the delivery prediction model to predict, based on order data, user data and fulfillment data, the likelihood of the failed delivery for the order. Responsive to the predicted likelihood of the failed delivery being greater than a threshold value, the online system identifies one or more actions associated with the order to prevent an occurrence of the failed delivery for the order. The online system applies the one or more actions to prevent the occurrence of the failed delivery for the order.

### BACKGROUND

A failed delivery of an order that was placed by a user of an online system, such as an online concierge system, occurs when a delivery agent states that they delivered the order, but the intended recipient says that the order was never delivered. Although failed delivery orders (FDOs) are typically rare, they are extremely expensive for online systems. In addition to redelivery costs and costs of potentially losing users, the cost of the items needs to be covered. Hence, it is highly desirable to reduce a number of FDOs at an online system.

Some patterns of FDOs are predictable, e.g., difficulty with specific addresses, difficulty with nightly deliveries, etc. Because of that, it has been known that certain types of FDOs can be prevented by intervening, e.g., by providing delivery notifications to users, requiring users to be present for all deliveries in order to sign deliveries, asking a delivery agent to take a picture of a delivered order, etc. However, some of the intervening actions often come at a cost of adding friction to a fulfillment flow, thus increasing the time required for delivery, which increases total delivery costs. Also, some requirements add friction to the fulfillment flow, such as the requirement that users need to be present for delivery typically leads to cancellations or lower conversions. Thus, applying the attendance requirement during delivery for all users is costly and is a bad decision in terms of growth. Additionally, these frictions are not always effective. For example, introducing the requirement for a delivery agent to take a picture of a delivered order is typically not enough to guarantee prevention of an FDO for various reasons, such as the order can be stolen by a third party, a delivery address may be wrong, the delivery agent may leave with the order, etc.

Therefore, in order to have an effective way of preventing FDOs, an online system should assess the risks and benefits of adding frictions and add the frictions only where the benefits outweigh the costs. However, there are technical problems of how to predict FDOs at different stages of fulfillment, predict the benefits and costs of different frictions, and determine, at a large scale, whether to add a friction and what would be the most appropriate friction at a particular stage of an order fulfillment process to prevent FDOs without unnecessarily increasing costs or hurting growth of an order volume at the online system.

### SUMMARY

Embodiments of the present disclosure are directed to using a trained model to predict and prevent failed deliveries of orders placed at an online system (e.g., online concierge system).

In accordance with one or more aspects of the disclosure, the online system obtains order data with information about an order placed by a user of the online system. The online system retrieves, from a database of the online system, user data with information about the user. The online system dispatches a delivery agent to complete a fulfillment process for the order, wherein the fulfillment process for the order comprises delivering the order to a location associated with the user. The online system obtains fulfillment data associated with one or more stages of the fulfillment process for the order and during the fulfillment process for the order. The online system accesses a delivery prediction model of the online system, wherein the delivery prediction model is trained to predict a likelihood of a delivery for the order ending up as a failed delivery in which the online system receives confirmation of delivery from the delivery agent but also receives a message from the user that delivery did not occur. The online system applies the delivery prediction model to predict, based at least in part on the order data, the user data and the fulfillment data, the likelihood of the failed delivery for the order. The online system compares the predicted likelihood of the failed delivery with a threshold value. Responsive to the predicted likelihood of the failed delivery being greater than the threshold value, the online system identifies one or more actions associated with the order to prevent an occurrence of the failed delivery for the order. The online system applies the one or more actions at the online system to prevent the occurrence of the failed delivery for the order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example architectural flow diagram of using a trained model to prevent an occurrence of failed delivery of an order placed by a user of an online concierge system, in accordance with one or more embodiments.

FIG. 4A illustrates an example user interface of a device associated with a user of an online concierge system with a four-digit code for confirmation of a successful delivery of an order placed by the user, in accordance with one or more embodiments.

FIG. 4B illustrates an example user interface of a device of a delivery agent associated with an online concierge system with the four-digit code received from the user for confirmation of the successful delivery of the order, in accordance with one or more embodiments.

FIG. 5 is a flowchart for a method of using a trained model to prevent an occurrence of a failed delivery for an order placed by a user of an online concierge system, in accordance with one or more embodiments.

### DETAILED DESCRIPTION

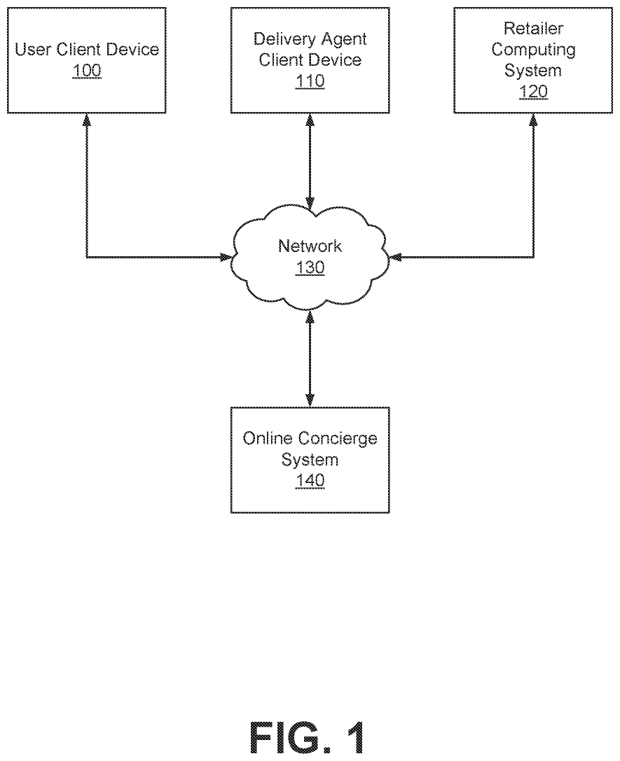

FIG. 1 illustrates an example system environment for an online concierge system 140, in accordance with one or more embodiments. The system environment illustrated in FIG. 1 includes a user client device 100, a delivery agent client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, delivery agent client device 110, and retailer computing system 120 are illustrated in FIG. 1, any number of users, delivery agents (or pickers), and retailers may interact with the online concierge system 140. As such, there may be more than one user client device 100, delivery agent client device 110, or retailer computing system 120. As a picker may also deliver an order placed by a user, thereby the picker may be the delivery agent as well. Hence, the terms “picker” and “delivery agent” can be interchangeable used herein.

The user client device 100 is a client device through which a user may interact with the delivery agent client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a delivery agent that is servicing the user's order. This communication interface allows the user to input a text-based message to transmit to the delivery agent client device 110 via the network 130. The delivery agent client device 110 receives the message from the user client device 100 and presents the message to the delivery agent. The delivery agent client device 110 also includes a communication interface that allows the delivery agent to communicate with the user. The delivery agent client device 110 transmits a message provided by the delivery agent to the user client device 100 via the network 130. In some embodiments, messages sent between the user client device 100 and the delivery agent client device 110 are transmitted through the online concierge system 140. In addition to text messages, the communication interfaces of the user client device 100 and the delivery agent client device 110 may allow the user and the delivery agent to communicate through audio or video communications, such as a phone call, a voice-over-IP call, or a video call.

The delivery agent device 110 is a client device through which a delivery agent (or picker) may interact with the user client device 100, the retailer computing system 120, or the online concierge system 140. The delivery agent client device 110 can be a personal or mobile computing device, such as a smartphone, a tablet, a laptop computer, or desktop computer. In some embodiments, the delivery agent client device 110 executes a client application that uses an application programming interface (API) to communicate with the online concierge system 140.

The delivery agent client device 110 receives orders from the online concierge system 140 for the delivery agent (or picker) to service. A delivery agent services an order by collecting the items listed in the order from a retailer. The delivery agent client device 110 presents the items that are included in the user's order to the delivery agent in a collection interface. The collection interface is a user interface that provides information to the delivery agent on which items to collect for a user's order and the quantities of the items. In some embodiments, the collection interface provides multiple orders from multiple users for the delivery agent to service at the same time from the same retailer location. The collection interface further presents instructions that the user may have included related to the collection of items in the order. Additionally, the collection interface may present a location of each item at the retailer, and may even specify a sequence in which the delivery agent should collect the items for improved efficiency in collecting items. In some embodiments, the delivery agent client device 110 transmits to the online concierge system 140 or the user client device 100 which items the delivery agent has collected in real time as the delivery agent collects the items.

The delivery agent can use the delivery agent client device 110 to keep track of the items that the delivery agent has collected to ensure that the delivery agent collects all of the items for an order. The delivery agent client device 110 may include a barcode scanner that can determine an item identifier encoded in a barcode coupled to an item. The delivery agent client device 110 compares this item identifier to items in the order that the delivery agent is servicing, and if the item identifier corresponds to an item in the order, the delivery agent client device 110 identifies the item as collected. In some embodiments, rather than or in addition to using a barcode scanner, the delivery agent client device 110 captures one or more images of the item and determines the item identifier for the item based on the images. The delivery agent client device 110 may determine the item identifier directly or by transmitting the images to the online concierge system 140. Furthermore, the delivery agent client device 110 determines a weight for items that are priced by weight. The delivery agent client device 110 may prompt the delivery agent to manually input the weight of an item or may communicate with a weighing system in the retailer location to receive the weight of an item.

When the delivery agent has collected all of the items for an order, the delivery agent client device 110 instructs a delivery agent on where to deliver the items for a user's order. For example, the delivery agent client device 110 displays a delivery location from the order to the delivery agent. The delivery agent client device 110 also provides navigation instructions for the delivery agent to travel from the retailer location to the delivery location. When a delivery agent is servicing more than one order, the delivery agent client device 110 identifies which items should be delivered to which delivery location. The delivery agent client device 110 may provide navigation instructions from the retailer location to each of the delivery locations. The delivery agent client device 110 may receive one or more delivery locations from the online concierge system 140 and may provide the delivery locations to the delivery agent so that the delivery agent can deliver the corresponding one or more orders to those locations. The delivery agent client device 110 may also provide navigation instructions for the delivery agent from the retailer location from which the delivery agent collected the items to the one or more delivery locations.

In some embodiments, the delivery agent client device 110 tracks the location of the delivery agent as the delivery agent delivers orders to delivery locations. The delivery agent client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the delivery agent based on the delivery agent's location. For example, if the delivery agent takes a wrong turn while traveling to a delivery location, the online concierge system 140 determines the delivery agent's updated location based on location data from the delivery agent client device 110 and generates updated navigation instructions for the delivery agent based on the updated location.

In one or more embodiments, the delivery agent is a single person who collects items for an order from a retailer location and delivers the order to the delivery location for the order. Alternatively, more than one person may serve the role as a delivery agent for an order. For example, multiple people may collect the items at the retailer location for a single order. Similarly, the person who delivers an order to its delivery location may be different from the person or people who collected the items from the retailer location. In these embodiments, each person may have a delivery agent client device 110 that they can use to interact with the online concierge system 140.

Additionally, while the description herein may primarily refer to delivery agents as humans, in some embodiments, some or all of the steps taken by the delivery agent may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a delivery agent can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the delivery agent client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a delivery agent from a retailer. The online concierge system 140 receives orders from the user client device 100 through the network 130. The online concierge system 140 selects a delivery agent to service the user's order and transmits the order to the delivery agent client device 110 associated with the delivery agent. The delivery agent collects the ordered items from a retailer location and delivers the ordered items to the user. The online concierge system 140 may charge a user for the order and provide portions of the payment from the user to the delivery agent and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a delivery agent to travel to the grocery store retailer location to collect the groceries ordered by the user. Once the delivery agent has collected the groceries ordered by the user, the delivery agent delivers the groceries to a location transmitted to the delivery agent client device 110 by the online concierge system 140.

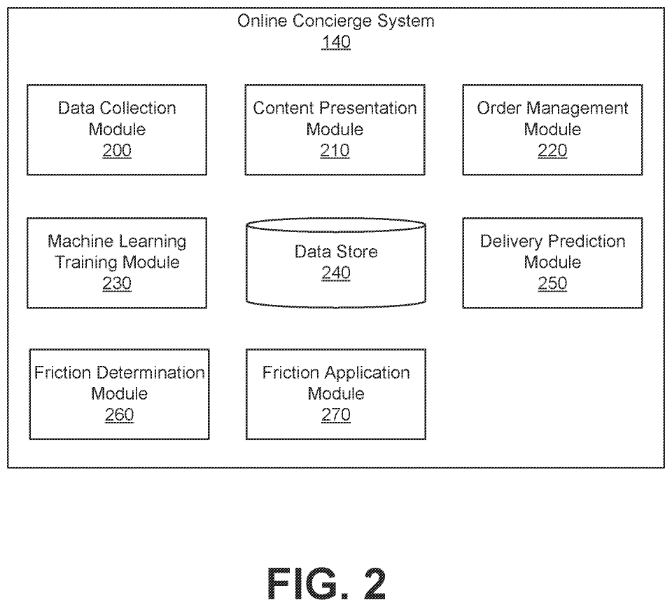

The online concierge system 140 fulfills orders placed by users online by dispatching delivery agents (i.e., pickers) to pick the orders at local retailers and then deliver the orders to users addresses. A failed delivery order (FDO) occurs when a delivery agent states that they delivered the order at a user address, but the user says that the order was never delivered. To reduce a number of FDOs (or to entirely eliminate FDOs), the online concierge system 140 may train a model (e.g., machine-learning model) to predict a likelihood of an FDO at one or more stages of an order fulfillment process, where the trained model takes information obtained up to the current stage of the order fulfillment process. Based on the predicted likelihood of the FDO, the online concierge system 140 may determine whether to add a friction requirement to the checkout and delivery flow, such as asking a delivery agent to confirm a passphrase with a user upon delivery, preventing a user from scheduling an evening delivery time, etc. The trained model may determine at what stage of an order fulfillment process to add a specific friction requirement. And different friction requirements may be associated with different stages of the order fulfillment process. Hence, the online concierge system 140 leverages the trained model to predict a failed delivery and triggers an appropriate action (e.g., adding friction) if a likelihood of a failed delivery is high enough. By applying the trained model, the online concierge system 140 may prevent FDOs without negatively affecting user conversions and delivery costs. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a delivery prediction module 250, a friction determination module 260, and a friction application module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a delivery agent looked for the item but could not find it), the rate at which the item is found, or the popularity of the item. The data collection module 200 may collect the item data from the retailer computing system 120, the delivery agent client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects delivery agent data, which is information or data that describes characteristics of delivery agents. For example, the data collection module 200 may collect the delivery agent data for a delivery agent that include the delivery agent's name, the delivery agent's location, how often the delivery agent has serviced orders for the online concierge system 140, a user rating for the delivery agent, which retailers the delivery agent has collected items at, or the delivery agent's previous shopping history. Additionally, the data collection module 200 may collect the delivery agent data that include preferences expressed by the delivery agent, such as their preferred retailers to collect items at, how far they are willing to travel to deliver items to a user, how many items they are willing to collect at a time, timeframes within which the delivery agent is willing to service orders, or payment information by which the delivery agent is to be paid for servicing orders (e.g., a bank account). The data collection module 200 collects the delivery agent data from sensors of the delivery agent client device 110 or from the delivery agent's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which delivery agent serviced the order, when the order was delivered, or a rating that the user gave the delivery of the order. In some embodiments, the data collection module 200 collects the order data that include user data for users associated with the order, such as user data for a user who placed the order or delivery agent data for a delivery agent who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to delivery agents for service based on delivery agent data. For example, the order management module 220 assigns an order to a delivery agent based on the delivery agent's location and the location of the retailer from which the ordered items are to be collected. The order management module 220 may also assign an order to a delivery agent based on how many items are in the order, a vehicle operated by the delivery agent, the delivery location, the delivery agent's preferences on how far to travel to deliver an order, the delivery agent's ratings by users, or how often a delivery agent agrees to service an order.

In some embodiments, the order management module 220 determines when to assign an order to a delivery agent based on a delivery timeframe requested by the user with the order. The order management module 220 computes an estimated amount of time that it would take for a delivery agent to collect the items for an order and deliver the ordered items to the delivery location for the order. The order management module 220 assigns the order to a delivery agent at a time such that, if the delivery agent immediately services the order, the delivery agent is likely to deliver the order at a time within the requested timeframe. Thus, when the order management module 220 receives an order, the order management module 220 may delay in assigning the order to a delivery agent if the requested timeframe is far enough in the future (i.e., the delivery agent may be assigned at a later time and is still predicted to meet the requested timeframe).

When the order management module 220 assigns an order to a delivery agent, the order management module 220 transmits the order to the delivery agent client device 110 associated with the delivery agent. The order management module 220 may also transmit navigation instructions from the delivery agent's current location to the retailer location associated with the order. If the order includes items to collect from multiple retailer locations, the order management module 220 identifies the retailer locations to the delivery agent and may also specify a sequence in which the delivery agent should visit the retailer locations.

The order management module 220 may track the location of the delivery agent through the delivery agent client device 110 to determine when the delivery agent arrives at the retailer location. When the delivery agent arrives at the retailer location, the order management module 220 transmits the order to the delivery agent client device 110 for display to the delivery agent. As the delivery agent uses the delivery agent client device 110 to collect items at the retailer location, the order management module 220 receives item identifiers for items that the delivery agent has collected for the order. In some embodiments, the order management module 220 receives images of items from the delivery agent client device 110 and applies computer-vision techniques to the images to identify the items depicted by the images. The order management module 220 may track the progress of the delivery agent as the delivery agent collects items for an order and may transmit progress updates to the user client device 100 that describe which items have been collected for the user's order.

In some embodiments, the order management module 220 tracks the location of the delivery agent within the retailer location. The order management module 220 uses sensor data from the delivery agent client device 110 or from sensors in the retailer location to determine the location of the delivery agent in the retailer location. The order management module 220 may transmit, to the delivery agent client device 110, instructions to display a map of the retailer location indicating where in the retailer location the delivery agent is located. Additionally, the order management module 220 may instruct the delivery agent client device 110 to display the locations of items for the delivery agent to collect, and may further display navigation instructions for how the delivery agent can travel from their current location to the location of a next item to collect for an order.

The order management module 220 determines when the delivery agent has collected all of the items for an order. For example, the order management module 220 may receive a message from the delivery agent client device 110 indicating that all of the items for an order have been collected. Alternatively, the order management module 220 may receive item identifiers for items collected by the delivery agent and determine when all of the items in an order have been collected. When the order management module 220 determines that the delivery agent has completed an order, the order management module 220 transmits the delivery location for the order to the delivery agent client device 110. The order management module 220 may also transmit navigation instructions to the delivery agent client device 110 that specify how to travel from the retailer location to the delivery location, or to a subsequent retailer location for further item collection. The order management module 220 tracks the location of the delivery agent as the delivery agent travels to the delivery location for an order, and updates the user with the location of the delivery agent so that the user can track the progress of the order. In some embodiments, the order management module 220 computes an estimated time of arrival of the delivery agent at the delivery location and provides the estimated time of arrival to the user.

In some embodiments, the order management module 220 facilitates communication between the user client device 100 and the delivery agent client device 110. As noted above, a user may use the user client device 100 to send a message to the delivery agent client device 110. The order management module 220 receives the message from the user client device 100 and transmits the message to the delivery agent client device 110 for presentation to the delivery agent. The delivery agent may use the delivery agent client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the delivery agent for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, delivery agent data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and delivery agent data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The delivery prediction module 250 may determine how likely is that an order placed by a user of the online concierge system 140 will end up as a failed delivery (i.e., not being delivered to the user). The delivery prediction module 250 may access a delivery prediction model (e.g., machine-learning model) that is trained to predict a likelihood of a failed delivery for the order. The delivery prediction module 250 may deploy the delivery prediction model to run a machine-learning algorithm to predict, based on a set of inputs, the likelihood that the order will not be delivered to the user. The delivery prediction model may be implemented as, e.g., a decision tree model that applies a decision tree gradient boosted algorithm to output a probability between 0-100% (i.e., likelihood between 0 and 1) that a delivery for an order will end up as the failed delivery. A set of parameters for the delivery prediction model may be stored at one or more non-transitory computer-readable media of the delivery prediction module 250. Alternatively, the set of parameters for the delivery prediction model may be stored at one or more non-transitory computer-readable media of the data store 240.

The delivery prediction module 250 may provide the set of inputs representing various input features to the delivery prediction model. The input features provided to the delivery prediction model may depend on what stage in the order fulfillment process the delivery prediction model is being run. For example, the delivery prediction model cannot use features of a delivery agent associated with the online concierge system 140 if the delivery agent is not yet paired with a specific order placed at the online concierge system 140. The set of inputs provided by the delivery prediction module 250 to the delivery prediction model may include various features, such as user address features, order related features, user related features, timing features, some other features, or some combination thereof.

The user address features input into the delivery prediction model may include: a type of a delivery address (e.g., house, apartment, etc.), an address delivery time, an address handoff time, an FDO rate for the delivery address, information about past orders associated with the delivery address, etc. The order related features input into the delivery prediction model may include: a number of items in the order, information on whether this is an unattended delivery, information on how much ahead of delivery the order was placed, information about a retailer, information about a type of retailer, an initial charge amount associated with the order, a maximum item unit price, a maximum item price, a number of items in the order having a monetary value between a first amount ($50.00) and a second amount ($1,000.00), etc. The user related features input into the delivery prediction model may include information about a tenure of a user at the online concierge system 140, information about past orders placed by the user, an FDO rate for the user, etc. The timing features input into the delivery prediction model may include information about a day of week when the order was placed, a time of day when the order was placed, a time of day when the order needs to be delivered, etc.

Responsive to the predicted likelihood of the failed delivery output by the delivery prediction model being greater than a threshold value (e.g., the threshold likelihood of 0.5), the friction determination module 260 may determine one or more friction actions that should be applied in relation to the order to prevent an occurrence of the failed delivery for the order. In one or more embodiments, the friction determination module 260 determines (e.g., at the user's checkout) that the pin-exchange is required between the user and the delivery agent in order for the delivery agent to confirm a successful completion of the fulfillment process. Alternatively or additionally, the friction determination module 260 may determine that a notification needs to be sent to the delivery agent to be careful with order delivery. Alternatively or additionally, the friction determination module 260 may determine that a delivery agent needs to take a specific number and types of pictures of delivery, such as pictures where a delivery address of a user is clearly visible along with delivered items of the order.

In one or more embodiments, in the case of the predicted likelihood of the failed delivery for an order being especially high (e.g., higher than a second threshold value, such as the threshold likelihood of 0.8), the friction determination module 260 may determine that a delivery agent who is delivering the order needs to collect a signature from a user upon delivery to confirm a successful delivery of the order. Alternatively or additionally, the friction determination module 260 may determine that a more experienced delivery agent (e.g., delivery agent with a longer tenure at the online concierge system 140) should be assigned to an order that was identified as “risky order” (i.e., order having an FDO rate higher than an order threshold rate). Alternatively, the friction determination module 260 may determine that a more skilled delivery agent (i.e., delivery agent with an FDO rate below a delivery agent threshold rate) should be assigned to the “risky order.” Alternatively or additionally, the more skilled delivery agent may be assigned to a batch of orders that are identified as “risky orders.”

The friction application module 270 may trigger application of various friction actions associated with an order that were previously determined by the friction determination module 260 to prevent the occurrence of the failed delivery for the order. In one or more embodiments, at the user's checkout, the friction application module 270 provides, via a user interface of the user client device 100, an identification number (e.g., four-digit code) to the user. The friction application module 270 may then trigger the content presentation module 210 to cause the user client device 100 to display a user interface with a first message prompting the user to provide the identification number to the delivery agent client device 110 at a delivery. The friction application module 270 may further trigger the content presentation module 210 to cause the delivery agent client device 110 to display a user interface with a second message prompting the delivery agent to enter the identification number obtained from the user to be able to mark the delivery as successfully completed.

Additionally or alternatively, the friction application module 270 may trigger the content presentation module 210 to cause the delivery agent client device 110 to display a user interface with one or more notification messages during a delivery stage of the order fulfillment process prompting a delivery agent to carefully deliver items of the order to a delivery address of the user. Additionally or alternatively, the friction application module 270 may trigger the content presentation module 210 to cause the delivery agent client device 110 to display (e.g., before delivery or at the time of delivery) a user interface with a message prompting the delivery agent to take more pictures that can confirm successful delivery of the order.

Additionally or alternatively, the friction application module 270 may assign a more reliable delivery agent (e.g., delivery agent with a low FDO rate) or a more experienced delivery agent to an order identified as a risky order (e.g., order with a particularly high likelihood of failed delivery). The assignment of a specific delivery agent to a risky order may occur immediately after the order was placed and before matching orders to delivery agents. Additionally or alternatively, the friction application module 270 may assign a single order to a delivery agent instead of assigning a batch order when a likelihood of the failed delivery for this order is particularly high. The assignment of the single order to the delivery agent may occur immediately after the order was placed and before matching orders to delivery agents. Additionally or alternatively, the friction application module 270 may disallow night delivery for an order having a particularly high likelihood of failed delivery. The action of disallowing night delivery may occur during order placement at checkout when a user picks a delivery window at a user interface of the user client device 100.

It should be noted that the friction application module 270 may apply different friction actions at different stages of an order fulfillment process. Because of that, the delivery prediction model may generate a predicted likelihood of failed delivery for an order at different stages of the order fulfillment process. In one or more embodiments, the delivery prediction model is composed of multiple delivery prediction sub-models that each generates a respective predicted likelihood of failed delivery for an order during a particular stage of an order fulfillment process. Each delivery prediction sub-model may be implemented as, e.g., a decision tree sub-model that applies a corresponding decision tree gradient boosted algorithm on a set of inputs to generate a predicted likelihood of failed delivery for an order during a particular stage of an order fulfillment process. The set of inputs provided to the delivery prediction sub-model may be order data, user data, as well as a portion of fulfilment data that were gathered up to the particular stage of the order fulfillment process.

The machine-learning training module 230 may perform initial training of the delivery prediction model. In one or more embodiments, the machine-learning training module 230 generates training data by gathering (e.g., from the data store 240) a random subset of historical data associated with successful deliveries of a first collection of orders and failed deliveries of a second collection of orders. The machine-learning training module 230 may train the delivery prediction model using the generated training data to generate an initial set of parameters of the delivery prediction model. Furthermore, the machine-learning training module 230 may collect feedback data with information on whether an order was successfully delivered to the user upon applying the one or more friction actions. The machine-learning training module 230 may re-train the delivery prediction model by updating the set of parameters of the delivery prediction model using the collected feedback data.

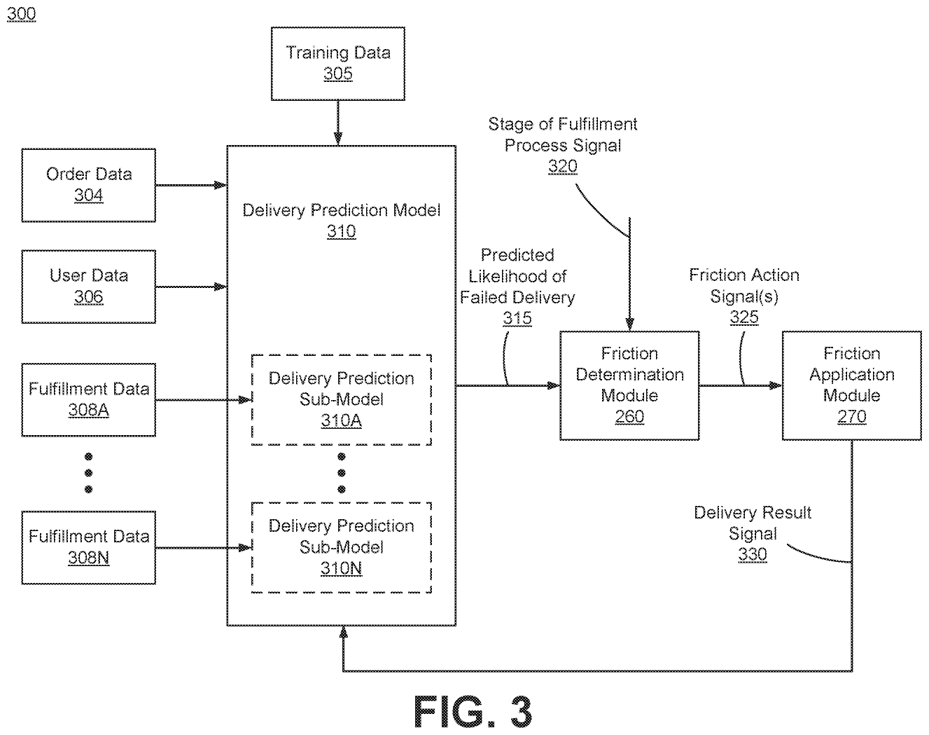

FIG. 3 illustrates an example architectural flow diagram 300 of using a delivery prediction model 310 to prevent an occurrence of failed delivery of an order placed by a user of the online concierge system 140, in accordance with one or more embodiments. First, the online concierge system 140 may perform (e.g., via the machine-learning training module 230) initial training of the delivery prediction model 310 using training data 305 to generate an initial set of parameters of the delivery prediction model 310. The training data 305 may be generated by gathering (e.g., via the machine-learning training module 230) a random subset of historical data associated with successful deliveries of a first collection of orders and failed deliveries of a second collection of orders.

After the training process is completed, the online concierge system 140 may provide (e.g., via the delivery prediction module 250) various inputs to the delivery prediction model 310, such as order data 304 and user data 306. In providing the order data 304 to the delivery prediction model 310, the online concierge system 140 may provide (e.g., via the delivery prediction module 250) information about a number of items in the order, information about a time period between a placement of the order and a scheduled delivery for the order, a monetary value associated with the order, a maximum item unit price in the order, a maximum item price in the order, information about a day of week when the order was placed, a time of day when the order was placed, a time of day when the order is scheduled for delivery, information about a retailer at which the order was placed, etc. Additionally, in providing the order data 304 to the delivery prediction model 310, the online concierge system 140 may provide (e.g., via the delivery prediction module 250) at least one of: a type of a delivery address associated with the order, a failed delivery rate associated with the delivery address, or information about one or more past orders associated with the delivery address. The online concierge system 140 may obtain order data 304 during a user's ordering session and at the user's checkout at the latest. The order data 304 may be gathered by the order management module 220 and provided to the delivery prediction module 250 or directly to the delivery prediction model 310.

In providing the user data 306 to the delivery prediction model 310, the online concierge system 140 may provide (e.g., via the delivery prediction module 250) information about a tenure of the user at the online concierge system 140, information about past orders placed by the user, a rate of failed deliveries for the user, some other user related information, or some combination thereof. The user data 306 may be retrieved by the delivery prediction module 250 from the data store 240 during the user's ordering session and provided to the delivery prediction model 310.

In addition to the order data 304 and the user data 306 collected before a start of an order fulfillment process, various data collected during the order fulfillment process (i.e., fulfillment data) may be also input to the delivery prediction model 310 during different stages of the order fulfillment process. For example, fulfillment data 308A provided to the delivery prediction model 310 may include information about a delivery agent associated with the online concierge system 140 who is matched with the user's order, information about a tenure of the delivery agent with the online concierge system 140, information about an FDO rate of the delivery agent, information on whether the delivery agent is scheduled to deliver a single order or a batch of orders, some other delivery agent related information, or some combination thereof. The fulfillment data 308A may be gathered by the order management module 220 and/or the delivery prediction module 250 after the user's checkout and before pairing delivery agents with orders that were placed at the online concierge system 140.

Furthermore, fulfillment data 308N provided to the delivery prediction model 310 may include information about a time of a delivery of the order, information about a time of handoff of items at the delivery address, information on whether the delivery is unattended, some other delivery related information, or some combination thereof. The fulfillment data 308N may be received, via the network 310, from the delivery agent client device 110 at the delivery prediction module 250 during, e.g., a delivery stage of the order fulfillment process. In addition to the fulfillment data 308A, 308N, additional fulfillment data may be gathered during one or more other stages of the order fulfillment process, such as during shopping of items by the delivery agent, during the delivery agent's checkout at a location of a retailer associated with the online concierge system 140, etc.

The delivery prediction model 310 may output, based on the order data 304, the user data 306, and the fulfillment data 308A, . . . , 308N, a predicted likelihood of failed delivery 315 for the order. The delivery prediction model 310 may be implemented as, e.g., a decision tree model that applies a decision tree gradient boosted algorithm to output the predicted likelihood of failed delivery 315 as the value between 0 and 1, which corresponds to a probability of failed delivery between 0 and 100%. The delivery prediction model 310 may output the predicted likelihood of failed delivery 315 at one or more stages of the order fulfillment process.

In one or more embodiments, the delivery prediction model 310 includes multiple delivery prediction sub-models 310A, . . . , 310N each associated with a specific stage of the order fulfillment process. For example, the delivery prediction sub-model 310A may be associated with a stage of the order fulfillment process after the user's checkout and before pairing of delivery agents with orders. In addition to the order data 304 and the user data 306, the fulfillment data 308A (e.g., delivery agent related data) may be input to the delivery prediction sub-model 310A. The delivery prediction sub-model 310A may apply a machine-learning algorithm (e.g., decision tree gradient boosted algorithm) to the user data 304, the user data 306 and the fulfillment data 308A to output the predicted likelihood of failed delivery 315 at the stage of the order fulfillment process before pairing delivery agents with orders. The delivery prediction sub-model 310N may be associated with the delivery stage of the order fulfillment process. In addition to the order data 304 and the user data 306, the fulfillment data 308N (e.g., delivery related data) may be input to the delivery prediction sub-model 310N. The delivery prediction sub-model 310N may apply a machine-learning algorithm (e.g., decision tree gradient boosted algorithm) to the user data 304, the user data 306 and the fulfillment data 308N to output the predicted likelihood of failed delivery 315 during the delivery stage of the order fulfillment process. The predicted likelihood of failed delivery 315 may be passed to the friction determination module 260.

The friction determination module 260 may determine one or more actions associated with the order to prevent an occurrence of the failed delivery for the order. Upon reception of the predicted likelihood of failed delivery 315, the friction determination module 260 may compare the predicted likelihood of failed delivery 315 with a predetermined threshold likelihood (e.g., likelihood of 0.5). Responsive to the predicted likelihood of the failed delivery 315 being greater than the predetermined threshold likelihood, the friction determination module 260 may apply a set of predetermined rules to the predicted likelihood of failed delivery 315 as well as to a signal 320 that is indicative of a stage of the order fulfillment process. Using the predicted likelihood of failed delivery 315 and the signal 320, the friction determination module 260 may determine one or more friction actions for application at the online concierge system 140 to prevent an occurrence of the failed delivery of the order. The one or more friction actions determined by the friction determination module 260 may thus depend on the predicted likelihood of failed delivery 315 as well as on the stage of the order fulfillment process represented by the signal 320. Examples of the one or more friction actions are provided above in relation to FIG. 2. One or more signals 325 indicative of the one or more friction actions are passed to the friction application module 270.

Each friction action signal 325 may trigger a corresponding friction action applied by the friction application module 270 at a corresponding stage of the order fulfillment process. After performing all friction actions during the order fulfillment process, the friction application module 270 (or some other module of the online concierge system 140) may generate a delivery result signal 330 indicative of a delivery result for the order. For example, if the delivery result signal 330 has a bit value of “0”, the delivery of the order is marked as a failed delivery. And, if the delivery result signal 330 has a bit value of “1”, the delivery of the order is marked as a successful delivery. As the delivery result signal 330 carries information about a result of the most recent order delivery, the delivery result signal 330 may be utilized by the machine-learning training module 230 to re-train the delivery prediction model 310. By utilizing a delivery result signal 330 after completion of each order fulfillment process (or a predetermined order fulfillment process), the machine-learning training module 230 may continuously improve the set of parameters of the delivery prediction model 310 to provide an optimal predicted likelihood of failed delivery 315 for a given user, a given order and a specific order fulfillment process.

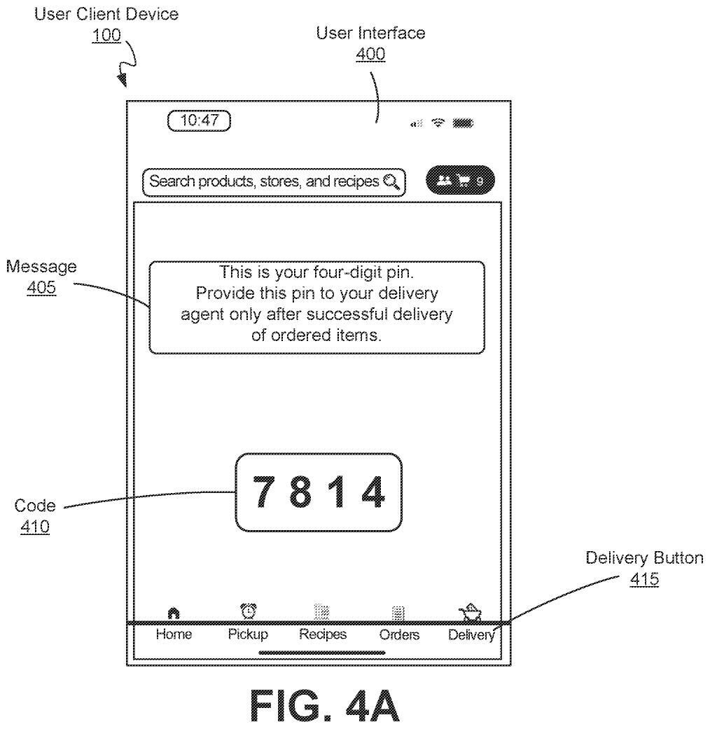

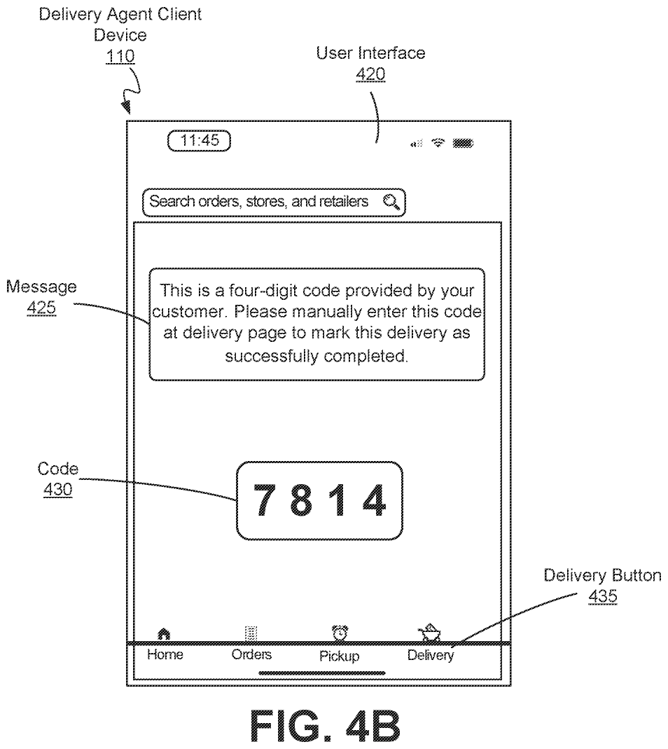

FIG. 4A illustrates an example user interface 400 of the user client device 100 with a four-digit code for confirmation of a successful delivery of an order placed by the user at the online concierge system 140, in accordance with one or more embodiments. The user interface 400 may be displayed at the user's checkout. Upon determination of a specific friction action based on an output of a delivery prediction model, the friction application module 270 may trigger the content presentation module 210 to cause the user interface 400 to display a message 405 along with a code 410 prompting the user to provide the code 410 (e.g., four-digit pin) to a delivery agent but only after successful delivery of items that the user ordered. Upon delivery of the ordered items to the user, the user may select a delivery button 415 that prompts a new interface of the user client device 100 that the user can use to manually enter the code 410. After manually entering the code 410, digital information about the code 410 may be communicated, via the network 130, to the delivery agent client device 110.

FIG. 4B illustrates an example user interface 420 of the delivery agent client device 110 with the four-digit code received from the user for confirmation of the successful delivery of the order, in accordance with one or more embodiments. The user interface 420 may be displayed after the delivery stage of the order fulfillment process is completed. After the user manually entered the code 410 at the user interface of the user client device 100, the content presentation module 210 may cause the user interface 420 to display a message 425 along with a code 430 manually entered by the user (which is the same four-digit code 410 originally received by the user). The message 425 prompts the delivery agent to manually enter the code 430 at a delivery page to mark this delivery as successfully completed. The delivery agent may utilize a delivery button 435 to prompt a new interface of the delivery agent client device 100 that displays the delivery page. The delivery agent may then use an appropriate space at the delivery page to manually enter the code 430 and mark the delivery as successfully completed. Upon confirmation that the code manually entered by the delivery agent is identical to the original code 410 received by the user, a delivery result signal may be generated (e.g., the delivery result signal 330) indicative of the successful delivery of order. The delivery result signal may be then utilized (e.g., via the machine-learning training module 230) to re-train the delivery prediction model.

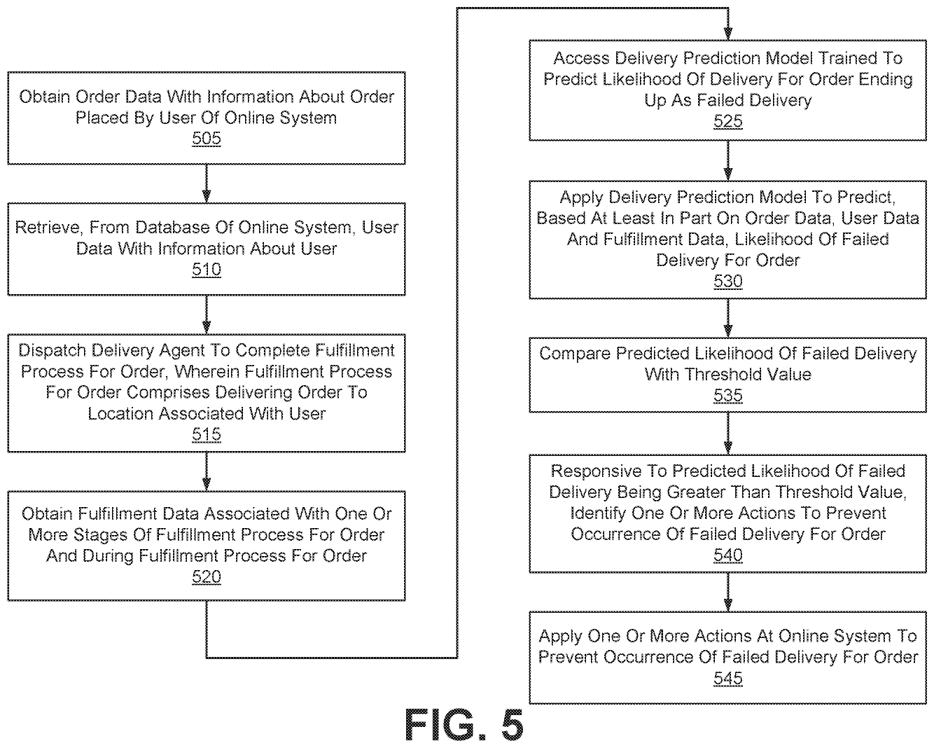

FIG. 5 is a flowchart for a method of using a trained model to prevent an occurrence of a failed delivery for an order placed by a user of an online concierge system, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., the online concierge system 140). Additionally, each of these steps may be performed automatically by the online concierge system without human intervention.

The online concierge system 140 obtains 505 (e.g., via the order management module 220 and/or the delivery prediction module 250) order data with information about an order placed by the user of the online concierge system 140. The online concierge system 140 retrieves 510 (e.g., via the delivery prediction module 250), from a database of the online concierge system 140 (e.g., database at the data store 240), user data with information about the user. The online concierge system 140 dispatches 515 (e.g., via the order management module 220 or the friction application module 270) a delivery agent to complete a fulfillment process for the order, wherein the fulfillment process for the order comprises delivering the order to a location associated with the user. The online concierge system 140 obtains 520 (e.g., via the delivery prediction module 250) fulfillment data associated with one or more stages of the fulfillment process for the order and during the fulfillment process for the order.

The online concierge system 140 may obtain the order data by receiving (e.g., at the order management module 220 and/or the delivery prediction module 250), from a device associated with the user (e.g., the user client device 100) via a network (e.g., the network 130), at least one of: information about a number of items in the order, information about a time period between a placement of the order and a scheduled delivery for the order, information about a retailer associated with the online concierge system 140, an initial monetary amount associated with the order, a maximum item unit price in the order, a maximum item price in the order, or a number of items in the order each having a monetary value between a first amount and a second amount. Alternatively or additionally, the online concierge system 140 may obtain the order data by receiving (e.g., at the order management module 220 and/or the delivery prediction module 250), from the device associated with the user via the network, at least one of: information about a day of week when the order was placed, a time of day when the order was placed, or a time of day when the order is scheduled for delivery. Alternatively or additionally, the online concierge system 140 may obtain the order data by retrieving (e.g., via the delivery prediction module 250), from the database, at least one of: information about a type of the location associated with the user, a failed delivery rate for the location associated with the user, or information about one or more past orders having a delivery address at the location associated with the user.

The online concierge system 140 may retrieve the user data by retrieving (e.g., via the delivery prediction module 250), from the database, at least one of: information about a tenure of the user with the online system, information about one or more past orders placed by the user, or a rate of failed deliveries for the user. The online concierge system 140 may obtain the fulfillment data by receiving (e.g., at the delivery prediction module 250), from a device associated with a delivery agent (e.g., the delivery agent client device 110) via the network during a delivery stage of the fulfillment process, at least one of: information about a time of a delivery of the order at the location associated with the user, information about a time of handoff of items in the order at the location associated with the user, or information on whether the delivery of the order is unattended.

The online concierge system 140 accesses 525 a delivery prediction model of the online concierge system 140 (e.g., via the delivery prediction module 250) that is trained to predict a likelihood of a delivery for the order ending up as a failed delivery in which the online concierge system 140 receives confirmation of delivery from the delivery agent but also receives a message from the user that delivery did not occur. The online concierge system 140 applies 530 the delivery prediction model (e.g., via the delivery prediction module 250) to predict, based at least in part on the order data, the user data and the fulfillment data, the likelihood of the failed delivery for the order. In one or more embodiments, the online concierge system 140 applies the delivery prediction model (e.g., via the delivery prediction module 250) to predict the likelihood of the failed delivery at each stage of the fulfillment process.

In one or more embodiments, the online concierge system 140 further retrieves (e.g., via the delivery prediction module 250), from the database, information about the delivery agent assigned to the order. The information about the delivery agent may include information about a rate of failed deliveries for the delivery agent, information about a tenure of the delivery agent with the online concierge system 140, and/or information about one or more features that make the delivery agent more error-prone for a certain type of order (e.g., a delivery agent who primarily shops in one geographic zone is now delivering to a location in a different geographic zone). The online concierge system 140 may then apply the delivery prediction model (e.g., via the delivery prediction module 250) to predict, further based on the information about the delivery agent, the likelihood of the failed delivery for the order.

The online concierge system 140 compares 535 (e.g., via the friction determination module 260) the predicted likelihood of the failed delivery with a threshold value. The online concierge system 140 may compare (e.g., via the friction determination module 260), at each stage of the fulfillment process, the predicted likelihood of the failed delivery with the threshold value associated with that stage of the fulfillment process. Responsive to the predicted likelihood of the failed delivery being greater than the threshold value, the online concierge system 140 identifies 540 (e.g., via the friction determination module 260) one or more actions associated with the order to prevent an occurrence of the failed delivery for the order. The online concierge system 140 applies 545 (e.g., via the friction application module 270) the one or more actions to prevent the occurrence of the failed delivery for the order. The online concierge system 140 may compute (e.g., via the friction determination module 260), at each stage of the fulfillment process, the threshold value that is indicative of a metric related to the cost and benefit to apply the one or more actions (e.g., add one or more frictions) given the likelihood of the failed delivery at that stage of the fulfillment process. The online concierge system 140 may determine (e.g., via the friction determination module 260), at each stage of the fulfillment process using information about one or more prior actions applied to prevent the occurrence of the failed delivery, the one or more actions to prevent the occurrence of the failed delivery for the order at that stage of the fulfillment process.

The online concierge system 140 may provide (e.g., via the friction application module 270), via a user interface of a device associated with the user (e.g., the user client device 100), an identification number to the user. The online concierge system 140 may cause (e.g., via the friction application module 270 and/or the content presentation module 210) the device associated with the user to display the user interface with a first message prompting the user to provide the identification number to the device associated with the delivery agent when the delivery agent delivers the order at the location associated with the user. The online concierge system 140 may cause (e.g., via the friction application module 270 and/or the content presentation module 210) the device associated with the delivery agent to display a user interface with a second message prompting the delivery agent to enter the identification number obtained from the user labeling the fulfillment process as successfully completed.

Alternatively or additionally, the online concierge system 140 may cause (e.g., via the friction application module 270 and the content presentation module 210) the device associated with the delivery agent to display a user interface with one or more notification messages during a delivery stage of the fulfillment process prompting the delivery agent to accurately deliver the order at the location associated with the user. Alternatively or additionally, the online concierge system 140 may assign (e.g., via the friction application module 270), during an initial stage of the fulfillment process, the delivery agent having a tenure with the online concierge system 140 longer than a threshold period to fulfill the order and deliver the order at the location associated with the user having a rate of failed deliveries higher than a threshold rate. Alternatively, the online concierge system 140 may assign (e.g., via the friction application module 270), during an initial stage of the fulfillment process, the delivery agent having a failed delivery rate lower than a first threshold rate to fulfill the order and deliver the order at the location associated with the user having a rate of failed deliveries higher than a second threshold rate.

In one or more embodiments, the online concierge system 140 applies the delivery prediction model by applying a corresponding delivery prediction sub-model of the delivery prediction model (e.g., via the delivery prediction module 250) to predict, based on the order data, the user data and a portion of the fulfillment data obtained during a corresponding stage of the fulfillment process, the likelihood of the failed delivery for the order. The online concierge system 140 may then apply (e.g., via the friction application module 270) the one or more actions during the corresponding stage of the fulfillment process to prevent the occurrence of the failed delivery for the order.

The online concierge system 140 may generate (e.g., via the machine-learning training module 230) training data by gathering (e.g., from the data store 240) a random subset of historical data associated with successful deliveries of a first collection of orders and failed deliveries of a second collection of orders. The online concierge system 140 may train (e.g., via the machine-learning training module 230) the delivery prediction model using the training data to generate an initial set of parameters of the delivery prediction model. The online concierge system 140 may collect (e.g., via the machine-learning training module 230) feedback data with information on whether the order was successfully delivered to the user upon applying the one or more actions. The online concierge system 140 may re-train the delivery prediction model by updating (e.g., via the machine-learning training module 230), using the collected feedback data, the set of parameters of the delivery prediction model.

Embodiments of the present disclosure are directed to the online concierge system 140 that uses a trained model that predicts a likelihood of failed delivery for an order placed at the online concierge system 140. Based on the predicted likelihood higher than a threshold likelihood, the online concierge system 140 triggers one or more friction actions during an order fulfillment process. Different friction actions can be applied at different stages of the fulfillment process, which may be triggered by outputs of different models applied at different stages of the order fulfillment process.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a computer-readable medium, comprising:
obtaining order data with information about an order placed by a user of an online system;
retrieving, from a database of the online system, user data with information about the user;
dispatching a delivery agent to complete a fulfillment process for the order, wherein the fulfillment process for the order comprises delivering the order to a location associated with the user;
obtaining, during the fulfillment process for the order, fulfillment data associated with a corresponding stage of a plurality of stages of the fulfillment process for the order;
accessing, during the corresponding stage of the fulfillment process, a delivery prediction machine-learning model of the online system, wherein the delivery prediction machine-learning model is trained to predict a likelihood of a delivery for the order ending up as a failed delivery in which the online system receives confirmation of delivery from the delivery agent but also receives a message from the user that delivery did not occur;
applying, during the corresponding stage of the fulfillment process, the delivery prediction machine-learning model to the order data, the user data, and the fulfillment data to generate the likelihood of the failed delivery for the order predicted during the corresponding stage of the fulfillment process;
comparing the likelihood of the failed delivery to a threshold value;
responsive to the likelihood of the failed delivery being greater than the threshold value, identifying a corresponding friction action associated with the corresponding stage of the fulfillment process to prevent an occurrence of the failed delivery for the order;
applying, during the corresponding stage of the fulfillment process, the corresponding friction action at the online system that causes a device associated with the delivery agent to display a user interface with content intended to prevent the occurrence of the failed delivery for the order, wherein, at one instance of the corresponding stage of the fulfillment process that represents a delivery stage of the fulfillment process, the content comprises an instruction for the delivery agent to take, using the device associated with the delivery agent, a specific number and types of pictures of a delivery of the order for confirming a successful delivery of the order;
sending, via a network and to a device associated with the user, a first user interface signal with information about an identification number, wherein the sending the first user interface signal causes the device associated with the user to display a first user interface with a first message, the identification number and a first user interface element, the first message prompting the user to enter the identification number using the first user interface element when the delivery agent delivers the order to the location associated with the user;
receiving, via the network and from the device associated with the user, the identification number;
responsive to receiving the identification number from the device associated with the user, sending, via the network and to the device associated with the delivery agent, a second user interface signal, wherein the sending the second user interface signal causes the device associated with the delivery agent to display a second user interface with a second message, the identification number, and a second user interface element, the second message prompting the delivery agent to enter the identification number using the second user interface element;
receiving, via the network and from the device associated with the delivery agent, a signal including the identification number and an indication of a successful completion of the fulfillment process;
responsive to receiving the signal, generating a delivery result signal including the indication about the successful completion of the fulfillment process; and
re-training the delivery prediction machine-learning model by updating, using the delivery result signal, a set of parameters of the delivery prediction machine-learning model.

2. The method of claim 1, wherein:
applying the delivery prediction machine-learning model comprises applying a corresponding delivery prediction machine-learning sub-model of a plurality of delivery prediction machine-learning sub-models of the delivery prediction machine-learning model to the order data, the user data and the fulfillment data obtained during the corresponding stage of the fulfillment process to generate the likelihood of the failed delivery for the order; and
the applying the corresponding friction action at the online system occurs during the corresponding stage of the fulfillment process to prevent the occurrence of the failed delivery for the order.

3. The method of claim 1, wherein obtaining the order data comprises:
receiving, from the device associated with the user and via the network, at least one of information about a number of items in the order, information about a time period between a placement of the order and a scheduled delivery for the order, information about a retailer associated with the online system, an initial monetary amount associated with the order, a maximum item unit price in the order, a maximum item price in the order, or a number of items in the order each having a monetary value between a first amount and a second amount.

4. The method of claim 1, wherein obtaining the order data comprises:
receiving, from the device associated with the user and via the network, at least one of information about a day of week when the order was placed, a time of day when the order was placed, or a time of day when the order is scheduled for delivery.

5. The method of claim 1, wherein obtaining the order data comprises:
retrieving, from the database, at least one of information about a type of location associated with the user, a failed delivery rate for the location associated with the user, or information about one or more past orders having a delivery address at the location associated with the user.

6. The method of claim 1, wherein retrieving the user data comprises:
retrieving, from the database, at least one of information about a tenure of the user with the online system, information about one or more past orders placed by the user, or a rate of failed deliveries for the user.

7. The method of claim 1, wherein obtaining the fulfillment data comprises:
receiving, from the device associated with the delivery agent and via the network during the delivery stage of the fulfillment process, at least one of information about a time of the delivery of the order at the location associated with the user, information about a time of handoff of items in the order at the location associated with the user, or information on whether the delivery of the order is unattended.

8. The method of claim 1, further comprising:
retrieving, from the database, information about the delivery agent assigned to the order, wherein
applying the delivery prediction machine-learning model comprises applying the delivery prediction machine-learning model further to the information about the delivery agent to generate the likelihood of the failed delivery for the order.

9. (canceled)

10. The method of claim 1, wherein applying the corresponding friction action further comprises:
sending, via the network and to the device associated with the delivery agent, a third user interface signal, wherein the sending the third user interface signal causes the device associated with the delivery agent to display a third user interface with one or more notification messages during the delivery stage of the fulfillment process prompting the delivery agent to accurately deliver the order to the location associated with the user.

11. The method of claim 1, wherein applying the corresponding friction action further comprises:
assigning the delivery agent having a tenure with the online system longer than a threshold period to fulfill the order and deliver the order at the location associated with the user having a rate of failed deliveries higher than a threshold rate.

12. The method of claim 1, wherein applying the corresponding friction action further comprises:
assigning the delivery agent having a failed delivery rate lower than a first threshold rate to fulfill the order and deliver the order at the location of the user having a rate of failed deliveries higher than a second threshold rate.

13. The method of claim 1, further comprising:
generating training data by gathering a random subset of historical data associated with successful deliveries of a first collection of orders and failed deliveries of a second collection of orders;
training the delivery prediction machine-learning model using the training data to generate the set of parameters of the delivery prediction machine-learning model;
collecting feedback data with information on whether the order was successfully delivered to the user upon applying the corresponding friction action; and
re-training the delivery prediction machine-learning model by updating, using the collected feedback data, the set of parameters of the delivery prediction machine-learning model.

14. A computer program product comprising a non-transitory computer readable storage medium having instructions encoded thereon that, when executed by a processor, cause the processor to perform steps comprising:
obtaining order data with information about an order placed by a user of an online system;
retrieving, from a database of the online system, user data with information about the user;
dispatching a delivery agent to complete a fulfillment process for the order, wherein the fulfillment process for the order comprises delivering the order to a location associated with the user;
obtaining, during the fulfillment process for the order, fulfillment data associated with a corresponding stage of a plurality of stages of the fulfillment process for the order;
accessing, during the corresponding stage of the fulfillment process, a delivery prediction machine-learning model of the online system, wherein the delivery prediction machine-learning model is trained to predict a likelihood of a delivery for the order ending up as a failed delivery in which the online system receives confirmation of delivery from the delivery agent but also receives a message from the user that delivery did not occur;
applying, during the corresponding stage of the fulfillment process, the delivery prediction machine-learning model to the order data, the user data, and the fulfillment data to generate the likelihood of the failed delivery for the order predicted during the corresponding stage of the fulfillment process;
comparing the likelihood of the failed delivery to a threshold value;
responsive to the likelihood of the failed delivery being greater than the threshold value, identifying a corresponding friction action associated with the corresponding stage of the fulfillment process to prevent an occurrence of the failed delivery for the order;
applying, during the corresponding stage of the fulfillment process, the corresponding friction action at the online system that causes a device associated with the delivery agent to display a user interface with content intended to prevent the occurrence of the failed delivery for the order, wherein, at one instance of the corresponding stage of the fulfillment process that represents a delivery stage of the fulfillment process, the content comprises an instruction for the delivery agent to take, using the device associated with the delivery agent, a specific number and types of pictures of a delivery of the order for confirming a successful delivery of the order;
sending, via a network and to a device associated with the user, a first user interface signal with information about an identification number, wherein the sending the first user interface signal causes the device associated with the user to display a first user interface with a first message, the identification number and a first user interface element, the first message prompting the user to enter the identification number using the first user interface element when the delivery agent delivers the order to the location associated with the user,
receiving, via the network and from the device associated with the user, the identification number;
responsive to receiving the identification number from the device associated with the user, sending, via the network and to the device associated with the delivery agent, a second user interface signal, wherein the sending the second user interface signal causes the device associated with the delivery agent to display a second user interface with a second message, the identification number, and a second user interface element, the second message prompting the delivery agent to enter the identification number using the second user interface element;
receiving, via the network and from the device associated with the delivery agent, a signal including the identification number and an indication of a successful completion of the fulfillment process;
responsive to receiving the signal, generating a delivery result signal including the indication about the successful completion of the fulfillment process; and
re-training the delivery prediction machine-learning model by updating, using the delivery result signal, a set of parameters of the delivery prediction machine-learning model.

15. The computer program product of claim 14, wherein the instructions further cause the processor to perform steps comprising:
applying the delivery prediction machine-learning model by applying a corresponding delivery prediction machine-learning sub-model of a plurality of delivery prediction machine-learning sub-models of the delivery prediction machine-learning model to the order data, the user data and the fulfillment data obtained during the corresponding stage of the fulfillment process to generate the likelihood of the failed delivery for the order, and
wherein the applying the corresponding friction action at the online system occurs during the corresponding stage of the fulfillment process to prevent the occurrence of the failed delivery for the order.

16. The computer program product of claim 14, wherein the instructions further cause the processor to perform steps comprising:
receiving, from the device associated with the user and via the network, the order data including at least one of information about a number of items in the order, information about a time period between a placement of the order and a scheduled delivery for the order, information about a retailer associated with the online system, an initial monetary amount associated with the order, a maximum item unit price in the order, a maximum item price in the order, a number of items in the order each having a monetary value between a first amount and a second amount, information about a day of week when the order was placed, a time of day when the order was placed, or a time of day when the order is scheduled for delivery.

17. The computer program product of claim 14, wherein the instructions further cause the processor to perform steps comprising:
retrieving, from the database, at least one of information about a type of location associated with the user, a failed delivery rate for the location associated with the user, or information about one or more past orders having a delivery address at the location associated with the user;
retrieving, from the database, the user data including at least one of information about a tenure of the user with the online system, information about one or more past orders placed by the user, or a rate of failed deliveries for the user; and
receiving, from the device associated with the delivery agent and via the network during the delivery stage of the fulfillment process, the fulfillment data including at least one of information about a time of the delivery of the order at the location associated with the user, information about a time of handoff of items in the order at the location associated with the user, or information on whether the delivery of the order is unattended.

18. The computer program product of claim 14, wherein the instructions further cause the processor to perform steps comprising:
sending, via the network and to the device associated with the delivery agent, a third user interface signal, wherein the sending the third user interface signal causes the device associated with the delivery agent to display a third user interface with one or more notification messages during the delivery stage of the fulfillment process prompting the delivery agent to accurately deliver the order to the location associated with the user.

19. The computer program product of claim 14, wherein the instructions further cause the processor to perform steps comprising:
generating training data by gathering a random subset of historical data associated with successful deliveries of a first collection of orders and failed deliveries of a second collection of orders;
training the delivery prediction machine-learning model using the training data to generate the set of parameters of the delivery prediction machine-learning model;
collecting feedback data with information on whether the order was successfully delivered to the user upon applying the corresponding friction action; and
re-training the delivery prediction machine-learning model by updating, using the collected feedback data, the set of parameters of the delivery prediction machine-learning model.

20. A computer system comprising:
a processor; and
a non-transitory computer-readable storage medium having instructions that, when executed by the processor, cause the computer system to perform steps comprising:
obtaining order data with information about an order placed by a user of an online system;
retrieving, from a database of the online system, user data with information about the user;
dispatching a delivery agent to complete a fulfillment process for the order, wherein the fulfillment process for the order comprises delivering the order to a location associated with the user;
obtaining, during the fulfillment process for the order, fulfillment data associated with a corresponding stage of a plurality of stages of the fulfillment process for the order;
accessing, during the corresponding stage of the fulfillment process, a delivery prediction machine-learning model of the online system, wherein the delivery prediction machine-learning model is trained to predict a likelihood of a delivery for the order ending up as a failed delivery in which the online system receives confirmation of delivery from the delivery agent but also receives a message from the user that delivery did not occur;
applying, during the corresponding stage of the fulfillment process, the delivery prediction machine-learning model to the order data, the user data, and the fulfillment data to generate the likelihood of the failed delivery for the order predicted during the corresponding stage of the fulfillment process;
comparing the likelihood of the failed delivery to a threshold value;
responsive to the likelihood of the failed delivery being greater than the threshold value, identifying a corresponding friction action associated with the corresponding stage of the fulfillment process to prevent an occurrence of the failed delivery for the order;
applying, during the corresponding stage of the fulfillment process, the corresponding friction action at the online system that causes a device associated with the delivery agent to display a user interface with content intended to prevent the occurrence of the failed delivery for the order, wherein, at one instance of the corresponding stage of the fulfillment process that represents a delivery stage of the fulfillment process, the content comprises an instruction for the delivery agent to take, using the device associated with the delivery agent, a specific number and types of pictures of a delivery of the order for confirming a successful delivery of the order;
sending, via a network and to a device associated with the user, a first user interface signal with information about an identification number, wherein the sending the first user interface signal causes the device associated with the user to display a first user interface with a first message, the identification number and a first user interface element, the first message prompting the user to enter the identification number using the first user interface element when the delivery agent delivers the order to the location associated with the user;
receiving, via the network and from the device associated with the user, the identification number;
responsive to receiving the identification number from the device associated with the user, sending, via the network and to the device associated with the delivery agent, a second user interface signal, wherein the sending the second user interface signal causes the device associated with the delivery agent to display a second user interface with a second message, the identification number, and a second user interface element, the second message prompting the delivery agent to enter the identification number using the second user interface element;
receiving, via the network and from the device associated with the delivery agent, a signal including the identification number and an indication of a successful completion of the fulfillment process;
responsive to receiving the signal, generating a delivery result signal including the indication about the successful completion of the fulfillment process; and
re-training the delivery prediction machine-learning model by updating, using the delivery result signal, a set of parameters of the delivery prediction machine-learning model.
